(19) United States
(12) Patent Application Publication
(10) Pub. No.: US 2002/0010734 A1
(43) Pub. Date: Jan. 24, 2002

(54) Internetworked augmented reality system and method

(76) Inventors: John Franklin Ebersole, Bedford, NH (US); Todd Joseph Furlong, Goffstown, NH (US); John Franklin Ebersole JR., Bedford, NH (US); Richard Wade Madison, Merrimack, NH (US)

Correspondence Address: Mirick O'Connell DeMallie & Lougee, LLP, Suite 1700, 100 Front Street, Worcester, MA, 01608-1477, US

(21) Appl. No.: 09/776,133

(22) Filed: Feb. 2, 2001

Related U.S. Application Data
(60) Provisional application No. 60/180,001, filed on Feb. 3, 2000.
(60) Provisional application No. 60/184,578, filed on Feb. 24, 2000.
(60) Provisional application No. 60/192,730, filed on Mar. 27, 2000.

(51) Int. Cl. G06F 15/16

(52) U.S. Cl. 709/201

(57) ABSTRACT

A system is presented for an “internetworked augmented reality (AR) system” which consists of one or more Local Stations (which may be AR or Non-AR, at least one of which must be AR) and one or more Remote Stations (RS) (which may be AR or Non-AR) networked together. RSs can provide resources not available at a Local AR Station (LARS): databases, high performance computing (HPC), and methods by which a human can interact with the person(s) at the LARS(s). Preferred embodiments are presented: Training: a trainee is located at a LARS, while the instructor, located at a RS, monitors and controls training. Maintenance: the operator performs tasks at the LARS, while information and assistance is located at the RS. HPC: the LARS user visualizes results of computations performed remotely. Online shopping: shoppers evaluate virtual representations of real products, in the real setting in which they will be used. Design: experts in such fields as interior or exterior decorating, lighting, architecture, or engineering, can use the invention to collaborate with remote colleagues and utilize remote databases or a HPC. Navigation: mariners utilize a remote database that contains the latest information on warnings of hazards or preferred paths to follow. Situational Awareness: users benefit from up-to-date information received from remote computers or humans over a network. Testing: controllers at remote computers control testing procedures. Entertainment: multiple AR game players at different locations can play against each other over a network. Telepresence: viewers remotely experience AR.

### CROSS REFERENCE TO RELATED APPLICATIONS

This application claims priority of pending Provisional patent applications No. 60/180,001 filed Feb. 3, 2000; No. 60/184,578 filed Feb. 24, 2000; and No. 60/192,730 filed Mar. 27, 2000.

### FIELD OF THE INVENTION

This invention relates to linking augmented reality (AR) technology to computer network capabilities to enhance the scope of various classes of AR applications. Embodiments contemplated herein include, but are not limited to, training, maintenance, high-performance computing, online shopping, design, navigation, situational awareness, testing, entertainment, and telepresence.

### COPYRIGHT INFORMATION

A portion of the disclosure of this patent document contains material that is subject to copyright protection. The copyright owner has no objection to the facsimile reproduction by anyone of the patent document or the patent disclosure as it appears in the Patent and Trademark Office records but otherwise reserves all copyright works whatsoever.

### BACKGROUND OF THE INVENTION

Augmented Reality (AR) is a technology which overlays computer-generated (virtual) objects or information onto the physical (real) world, including optical, acoustical (localized or 3D sound), touch (heat, force and tactile feedback), olfactory (smell), and taste, as perceived by a user. This invention—internetworked AR—provides a system and method to connect a local AR Station to one or more Remote Stations and optionally one or more Local Stations via a network (e.g., wide-area network, local area network, wireless network, or Internet), permitting a wider range of applications than allowed by non-network-connected AR systems.

AR-based training can be limited by the unavailability of a competent trainer, both in communication of key training information and in the actual control of the training tasks. This invention addresses these needs by enhancing AR training with the capability for remote instruction and feedback, as well as permitting control of training tasks by the instructor. The goal is to allow trainees at remote AR training sites to benefit from the experience of an instructor without the instructor having to be present at the trainees' location(s).

In many conceivable AR-based maintenance tasks, personnel require access to a remote person for assistance, as well as access to a large and/or constantly changing database. This invention permits maintenance personnel to access the needed information and personnel by connecting to a remote database or a remote maintenance expert.

In engineering and scientific applications needing the results of HPC, such as AR-based visualization and interaction with computational fluid dynamics and finite element analysis calculations, local computers are often not fast enough to perform the needed calculations, nor able to store the resultant data, especially in real-time applications. This invention allows the engineer or scientist to perform many AR-based tasks as if the HPC and database (and collaborators if desired) were local, when in fact they are remote.

Online shopping is a booming industry, with an increasing number of consumers purchasing goods over the World Wide Web. One problem faced by consumers is the intangibility of products viewed on a computer monitor. It is difficult to visualize, for example, whether an item will fit in a certain space or match the decor of a home or office. This invention utilizes AR to overcome some of these drawbacks of online shopping. Objects downloaded from the Web can be placed in a room, viewed, and manipulated locally with an AR system. This gives consumers the capability to evaluate products in the setting in which they will be used, expanding the capabilities of web-based shopping. The invention permits collaboration among the buyer (at an AR Station), remote sales clerks, and remote advisors such as specialists or family members.

AR-based design in such fields as engineering, architecture, and lighting is limited to the information available locally to the designer, including information from databases, colleagues, and experts, and to the computing power of the local computer available to the designer. This invention significantly extends the capabilities of the AR-based user to perform such work.

Navigation and situational awareness applications can be limited by the ability of the user to access and view the latest information. Such users can benefit from internetworked AR through the overlay of pertinent information on a person's viewpoint. Time critical or frequently updated information can be accessed over a network connection to maximize the utility of an AR navigation or situational awareness aid.

AR testing is another area that can benefit from internetworked AR. Human-in-the-loop testing of equipment can be controlled by a remote test operator. The test operator can specify AR testing scenarios and evaluate performance of the system as the human uses the system to react to the artificial scenarios, all remotely controlled by the test operator.

Network gaming is an extremely popular area. In network gaming, a number of users at separate, network-connected terminals compete on a common virtual playing field. In an internetworked AR embodiment of online gaming, the players are AR system users who can see virtual representations of their opponents, or other virtual objects or players, in an otherwise real environment, creating a new kind of experience.

Telepresence is another area that could benefit from internetworked AR technology. A local user could achieve a remote AR experience via a network-connected camera augmented with virtual imagery.

### BRIEF DESCRIPTION OF THE DRAWINGS

FIG. 1 is a block diagram indicating the three basic components of the internetworked augmented reality (AR) invention: a Local AR Station, a network, and a Remote Station that can be AR or Non-AR.

FIG. 2 is a block diagram illustrating the extensibility of internetworked AR invention to include multiple Local Stations and/or multiple Remote Stations.

FIG. 3 is an expanded version of FIG. 1 indicating hardware components of an internetworked AR Station system.

FIG. 4 is a wiring diagram of an internetworked AR training embodiment of the invention.

FIG. 5 is a diagram representing a first-person view of a real room in a Non-AR mode.

FIG. 6 is a diagram representing an AR view of the real room of FIG. 5 augmented with virtual fire and smoke for a training embodiment of the invention.

FIG. 7 is a wiring diagram of an online shopping embodiment of the invention.

FIG. 8 is a diagram representing the real room of FIG. 5 augmented with a virtual automobile and streamlines for a high performance computing embodiment of the invention.

FIG. 9 is a diagram representing the real room of FIG. 5 augmented with virtual wiring information for a maintenance embodiment of the invention.

FIG. 10 is a diagram describing a sequence of web pages that lead to an AR view of the real room of FIG. 5 augmented with a virtual lamp for an online shopping or interior design embodiment of the invention.

FIG. 11 is a diagram of a telepresence version of the invention.

### DETAILED DESCRIPTION OF THE INVENTION

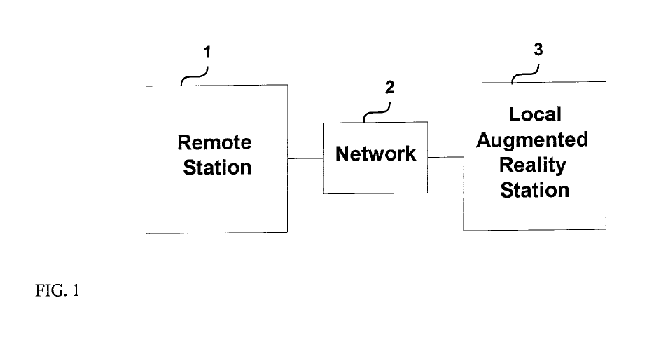

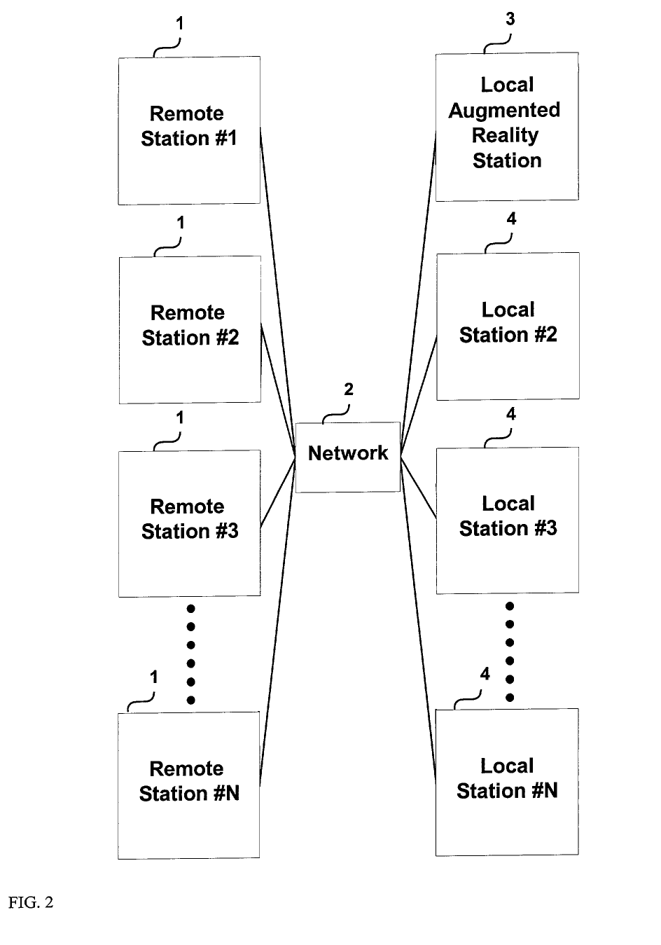

FIG. 1 is a block diagram indicating the basic concept. An internetworked AR system consists minimally of a Local Augmented Reality (AR) Station 3, a Remote Station 1 (which may be either an AR or Non-AR Station), and a network 2. The basic concept is extended in FIG. 2 where there is a Local AR Station 3, one or more AR or Non-AR Remote Stations 1, and zero or more additional Local Stations 4 (which may be either AR or Non-AR Stations) communicating over a network 2. The term “remote” is used here to convey the situation that two or more Stations do not share the same physical operating space, generally are physically distant, and often do not have a common line of sight to each other. The term “local” means not “remote.” While the preferred embodiments primarily describe optical (visual) AR and acoustic AR (localized or 3D sound), this invention also contemplates internetworking other forms of AR associated with stimulation of other human senses, including touch (heat, force, electricity, and tactile feedback), taste, and smell.

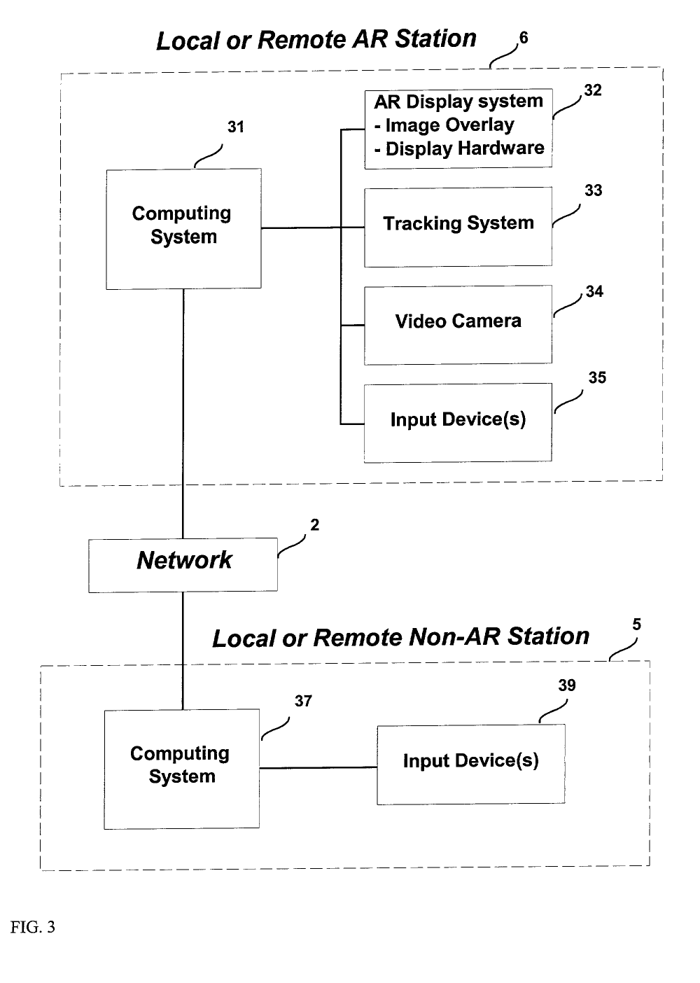

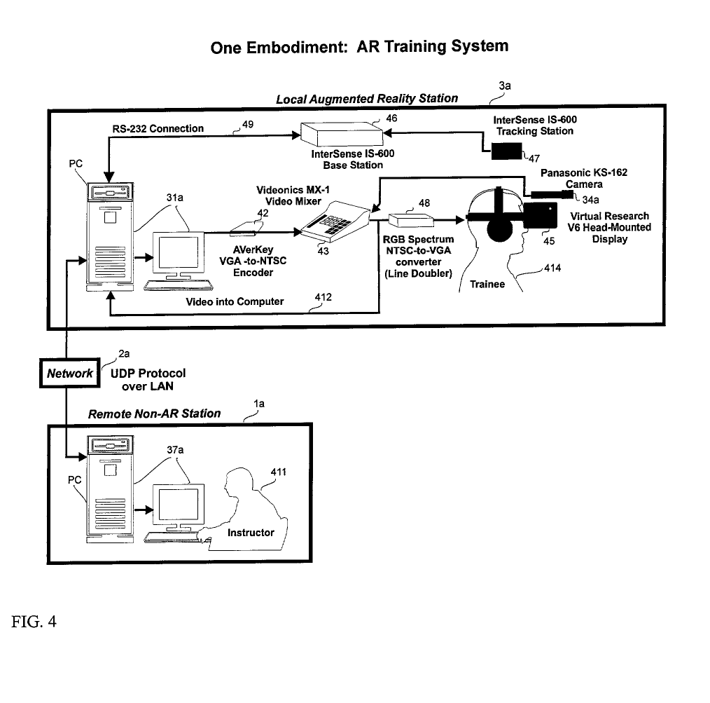

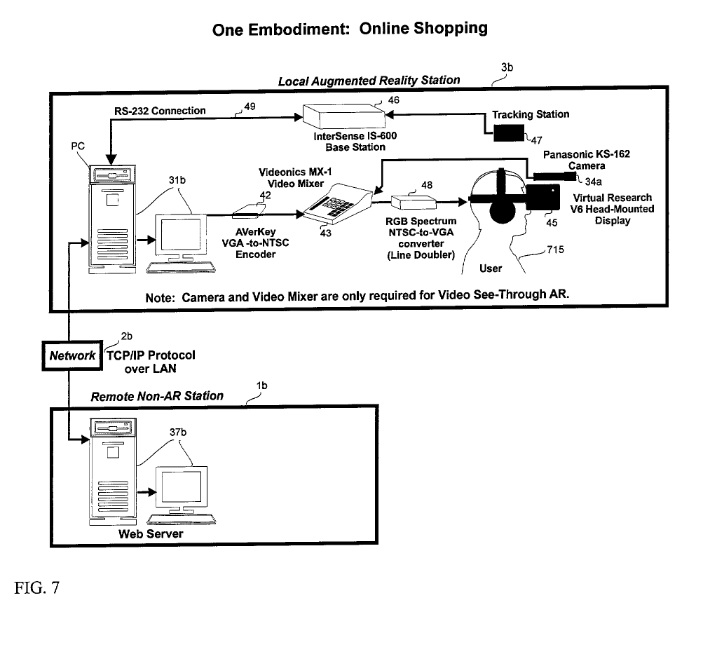

FIG. 3 is a more detailed version of FIG. 1 detailing the hardware components of a Local or Remote AR Station 6 and a Local or Remote Non-AR Station 5. FIG. 4 shows a specific implementation of the training preferred embodiment of the invention and associated hardware. FIG. 7 shows a specific implementation of the online shopping preferred embodiment of the invention and associated hardware.

In FIG. 3, an AR Station 3 has a computing system 31 as a key component. The computing system 31 may be a personal computer (PC), or it can be a higher end workstation for more graphics- and computation-intensive applications. The computing system 31 must have a connection to a network 2, a display system 32, a tracking system 33, and optionally a video camera 34 and input device 35. The video camera 34 and input device 35 are optional because they are not required for all applications or embodiments of the invention. However, they are used in at least one of the preferred embodiments.

In FIG. 3, the display system 32 (embodied as 42, 43, 45, 48 in FIG. 4) for an AR Station consists of hardware for generating graphics and for overlaying a virtual image onto a real-world scene. In an optical see-through AR system, image overlay is performed by the display hardware, but in a video see-through AR system image overlay is performed in a computer or with a video mixer (embodied as 42 in FIG. 4) before being sent to the display hardware. Display hardware for optical see-through AR can be a head-worn see-through display or a heads-up display (HUD). Display hardware for video see-through AR is an immersive head-mounted display (embodied as 45 in FIG. 4).

The tracking system 33 in FIG. 3 for an AR Station 3 tracks the AR Station user's head. The preferred embodiments described herein use the INTERSENSE IS-600™ (InterSense, Inc., 73 Second Avenue, Burlington, Mass. 01803, USA) (46, 47 in FIG. 4) acousto-inertial hybrid tracking system for tracking, but a number of other products and/or tracking technologies are applicable. Other tracker types include but are not limited to optical, acoustic, inertial, magnetic, compass, global positioning system (GPS) based, and hybrid systems consisting of two or more of these technologies.

In FIG. 3, the video camera 34 (embodied as 34a in FIG. 4) is necessary for video see-through AR systems and is head-worn, as that is the mechanism by which users are able to see the real world. The video camera contemplated for this invention can operate in the visible spectrum (approximately 0.4-0.7 micrometers wavelength), in the near-infrared (approximately 0.7-1.2 micrometers wavelength, just beyond visible range and where many infrared LEDs [light emitting diodes] operate), in the long-wave infrared (approximately 3-5 and 8-12 micrometers wavelength heat-sensitive) portion of the spectrum, and in the ultraviolet spectrum (less than approximately 0.4 micrometers wavelength). The video camera is also required for an optical see-through embodiment of a training or collaborative application (described below). In some embodiments, the video camera is used in conjunction with computing system 31 to capture and transmit an AR Station user's viewpoint to a Remote Station. The invention contemplates use of one of more commercial products for converting live video to a compressed real-time video stream for Internet viewing.

In FIG. 3, the input device 35 is another optional feature. With an input device, virtual objects may be placed and manipulated within the AR application. An input device can be as simple as a mouse or joystick, or it can be a glove or wand used for virtual reality applications. Other, custom, input devices can also be used. For example, the firefighter training application described below uses a real instrumented nozzle and an analog-to-digital converter as an input device.

In FIG. 3, the network 2 can be any type of network capable of transmitting the required data to enable an embodiment of the invention. This includes but is not limited to a local area network (LAN), wide area network (WAN), the Internet, or a wireless network. Standard network protocols such as TCP/IP or UDP can be used for communication between Stations.

In FIG. 3, for a Remote Non-AR Station 5, the computing system can be almost any kind of network-connected computer. In the preferred embodiment of a remote training system, the Non-AR Station computing system 37 is a PC with a standard monitor (37a in FIG. 4) and a keyboard and mouse as input devices 39. In the preferred embodiment of online shopping, the Remote Non-AR Station computing system 37 (37b in FIG. 7) is a web server. For a high performance computing embodiment, the Remote Non-AR Station computing system 37 is a high performance computer such as a supercomputer. For a maintenance embodiment, the Remote Non-AR Station computing system 37 is a computer containing a database of maintenance-related information, such as for automobiles, aircraft, buildings, appliances, or other objects requiring maintenance or repair. For other embodiments, the Remote Non-AR Station computing system 37 is simply a network-connected computer that meets the processing and/or video display capabilities of the particular application.

FIG. 4 is a wiring diagram indicating the hardware components of a preferred embodiment of an internetworked AR training system. Imagery from a head-worn video camera 34a, in this embodiment a PANASONIC GP-KS162™ (Matsushita Electric Corporation of America, One Panasonic Way, Secaucus, N.J. 07094 USA), is mixed in video mixer 43, in this embodiment a VIDEONICS MX-1™ (Videonics, Inc., 1370 Dell Ave., Campbell, Calif. 95008 USA), via a linear luminance key or chroma key with computer-generated (CG) output that has been converted to NTSC using an AVERKEY 3™ (AverMedia, Inc., 1161 Cadillac Court, Milpitas, Calif. 95035 USA) VGA-to-NTSC encoder 42. The luminance key or chroma key achieves AR by removing portions of the computer-generated imagery and replacing them with the camera imagery. Computer generated images are anchored to real-world locations using data from the INTERSENSE IS-600™ (InterSense, Inc., 73 Second Avenue, Burlington, Mass. 01803, USA) base station 46 and head-worn tracking station 47 that are used to determine the location and orientation of the camera 34a. A virtual-world viewpoint can then be set to match the real-world camera viewpoint. The mixed image is converted to VGA resolution with a line doubler 48, an RGB SPECTRUM DTQ™ (RGB Spectrum, 950 Marina village Parkway, Alameda, Calif. 94501 USA), and displayed to a user in a VIRTUAL RESEARCH V6™ (Virtual Research Systems, Inc., 2359 De La Cruz Blvd., Santa Clara, Calif. 95050 USA) head-mounted display (HMD) 45. The Local AR Station computer 31a captures the same images that are sent to the HMD and transfers them across a network 2a to the Remote Non-AR Station 1a. Input from the instructor 411 at the Remote Non-AR Station is transferred back across the network to give the trainee 414 guidance, and to control what the trainee sees in the HMD. The invention also allows for multiple trainees with AR equipment to interact with one or more remote operators or viewers, as in FIG. 2. In another training embodiment, the instructor 411 in FIG. 4 operates from a Remote AR Station.

In FIG. 4, the Local AR Station computer 31a and the Remote Non-AR Station computer 37a may both be standard PCs. New graphics cards have sufficient capabilities for AR applications, and minimal graphics capability is required at the Remote Non-AR Station. The Local AR Station requires the ability to digitize video, and therefore needs either a video capture card or such a capability built in to the PC. In this embodiment, an SGI 320™ (Silicon Graphics, Inc., 1600 Amphitheatre Pkwy, Mountain View, Calif. 94043 USA) PC was used as the Local AR Station computer 37a, and a number of different Pentium-class computers were tested as a Remote Non-AR Station. The SGI DIGITAL MEDIA LIBRARY™ (Silicon Graphics, Inc., 1600 Amphitheatre Pkwy., Mountain View, Calif. 94043 USA) was used in conjunction with the SGI 320™ to capture S-video video fields into system memory.

The VGA-to-NTSC encoder 42 in the equipment diagram of FIG. 4 may not be required for certain AR setups. If video mixing can be performed onboard the Local AR Station computer 31a, the computer-generated imagery can be sent directly to the HMD 45. Note that an optical see-through embodiment of the system would not require any method of video mixing for the user of the Local AR Station; however a head-mounted camera and a method of video mixing would be required to generate an AR video stream to be sent to the Remote Non-AR Station or Stations.

The training embodiment of the invention was implemented over a local-area network (LAN) using the UNIFIED MESSAGE PASSING™ (UMP™) library (The Boeing Company, PO Box 516, St. Louis, Mo. 63166-0516 USA), specifically the library's UDP (User Datagram Protocol) message passing capabilities over TCP/IP. The system should also function well over the Internet with sufficiently fast connections for both the trainee and instructor. The AR system code reduces the video size by cutting out rows and columns and sends a 160×60 image as an array of numbers in a single packet via the UMP protocol. The video size was chosen because it could be sent in a single packet, eliminating the need to assemble multiple packets into a video image at the Instructor Station. A more advanced system would use video streaming, possibly by creating a REALVIDEO™ (RealNetworks, Inc., 2601 Elliott Avenue, Suite 1000, Seattle, Wash., 98121) server at the AR system end for video transmission. The receive portion of the AR system code watches for ASCII codes to be received and treats them as key presses to control the simulation.

The Remote Non-AR Station program receives the video packets using the UMP protocol and draws them as 160×120 frames using OPENGL™ (Silicon Graphics, Inc., 1600 Amphitheatre Pkwy., Mountain View, Calif. 94043 USA). The Remote Non-AR Station accepts key presses from the instructor and sends them to the Local AR Station to control the simulation for the trainee.

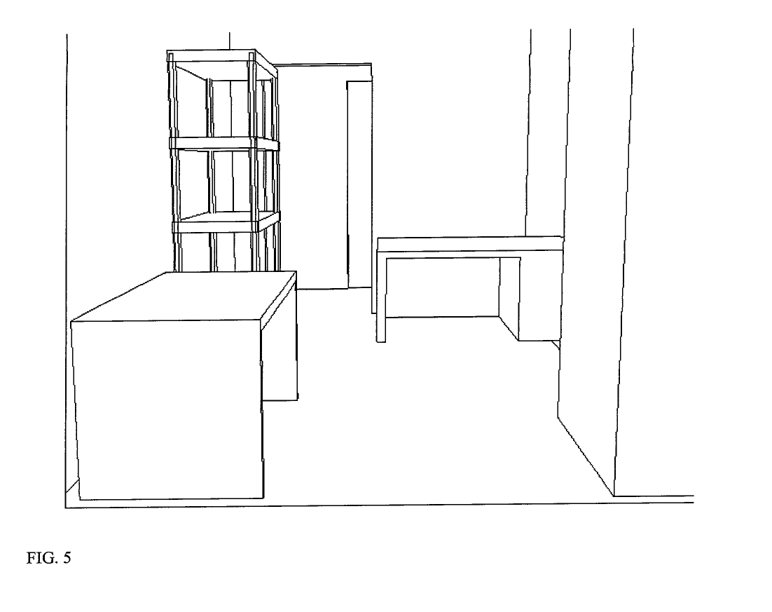

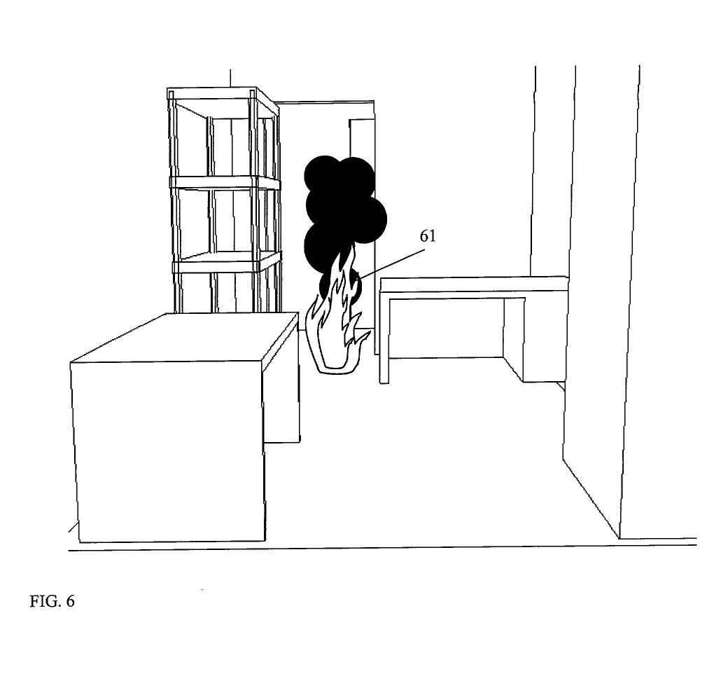

One specific application of a training embodiment for the invention is an AR-based firefighter training system. FIG. 5 represents a real room (without any AR yet) in which an AR-based firefighter training exercise may be conducted. FIG. 6 demonstrates the real room of FIG. 5 augmented with virtual fire and smoke 61. FIG. 6 is an example of what the trainee sees in the AR training application, and it is the same image that the instructor sees at the Remote Non-AR Station. The instructor remotely sees a video stream over a network of the trainee's AR viewpoint. The instructor is able to control parameters of the training simulation such as fire size and smoke layer height and density via key presses.

Another system enhancement contemplated for the invention is the ability for the instructor to remotely monitor one or more AR system trainees with a “God's eye” view (or any viewpoint) of their environment. The view can be created in AR using a camera or series of cameras that are either fixed or controllable remotely over the network by the remote viewer, or in VR using a 3-D room model that would allow viewing of the AR system users and the whole scene from any angle. Such a view would give a remote viewer (the instructor or observer) a different perspective on trainee performance, and perhaps a mouse click on a virtual representation of a trainee or group of trainees could call up information on those trainees, allow the remote viewer to switch to first-person perspective to watch a trainee's performance, or direct instructions to that particular individual or group.

FIG. 7 illustrates a preferred hardware setup for an online shopping embodiment of the invention. Note that there is no video input (as was shown as 412 in FIG. 4 for the training embodiment) to computer 31b, as this embodiment does not require transmission of AR images back to the Remote Non-AR Station if the AR application does not require access to a collaborative human.

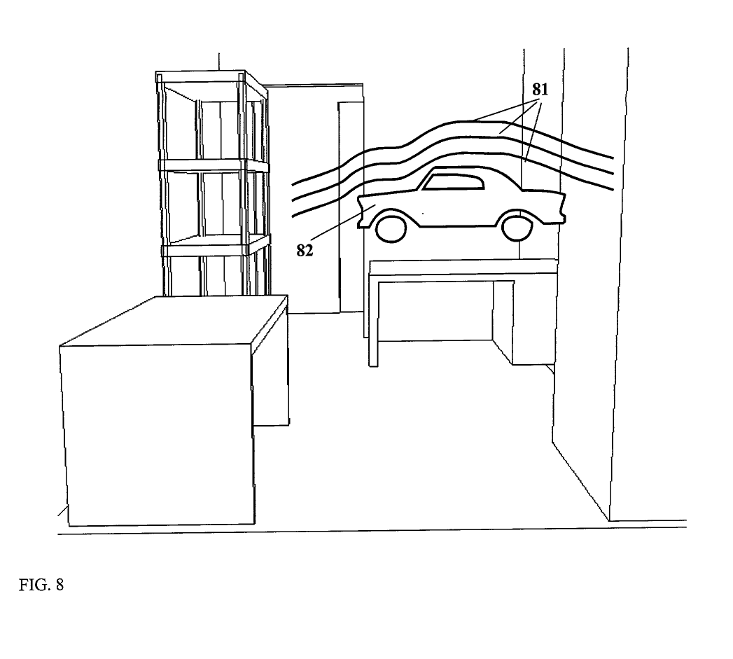

In FIG. 3, for a HPC or supercomputing embodiment, such as visualization of computational fluid dynamics (CFD), finite element analysis (FEA), or weather prediction, number crunching can be accomplished at a Remote Non-AR Station 5 which could include some form of HPC, and necessary data for AR display can be transmitted over a network 2 to a low-cost Local AR Station computer 31 for viewing by the Local AR Station user. The invention for this HPC embodiment also contemplates internetworked virtual reality viewing modes (in addition to AR viewing modes) by the Local AR Station user. An internetworked AR CFD application, an example of which is diagrammed in FIG. 8, could involve positioning a position-tracked mockup of a vehicle 82 and a position-tracked mockup of a wind tunnel fan (not shown) relative to each other. The relative positions of the mockups could be transmitted via network to an HPC for processing. Streamline or air pressure visualization information 81 could be transmitted back to the Local AR Station and overlaid on the vehicle mockup 82, allowing interactive CFD visualization by the Local AR Station user. The HPC could transmit any one of the following to achieve internetworked AR to the user (FIG. 3):

1. Numerical results allowing the Local AR Station 3 to generate and display an AR image of relevant CFD data;

2. A display list to be rendered at the Local AR Station 3 to generate and display an AR image of relevant CFD data;

3. An overlay image stream for the AR view (requires user HMD position data to be sent to the HPC via the network 2); or

4. An image stream of the entire combined AR view (also requires user HMD position data and complete video stream to be sent to the HPC).

Other applications for an HPC embodiment of the invention include but are not restricted to weather data overlaid on a real globe or FEA results calculated remotely and overlaid on a real prototype part.

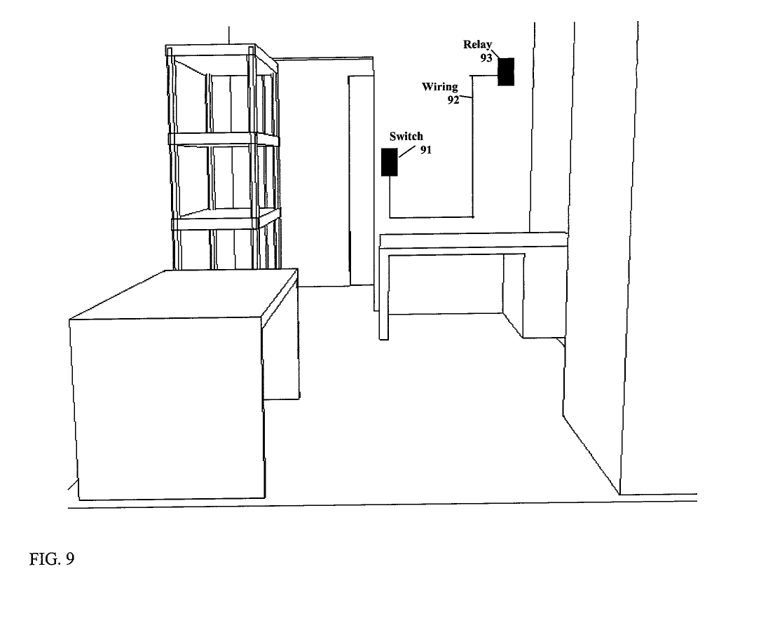

In FIG. 3, the maintenance preferred embodiment uses internetworked AR to improve AR-based maintenance tasks by providing access to remote databases. In this embodiment, the Remote Non-AR Station 5 is a network-connected database which contains, for example, wiring diagrams, maintenance tasks, or other information that a field technician might require on a maintenance or repair jobsite. FIG. 9 illustrates this concept. In the figure, images of a switch 91, wiring 92, and relay 93 are overlaid on a real room to indicate the location of these features to an electrician who would otherwise have to guess or drill to find them.

In FIG. 3, another preferred embodiment is the ability to better perform AR-based design using an internetworked AR system by providing access to remote databases and/or a HPC. This design embodiment includes but is not limited to electrical design, mechanical design, interior and exterior design, lighting design, and other engineering design. In the design embodiment, a user (the designer) has access via a network to a remote database (as in the maintenance embodiment). This database can include design components and information that could be assembled in AR to aid the design process, including creating a design for evaluation. Remote HPC capabilities can substantially enhance an AR-based design process in selected applications such as finite element analysis, heat transfer, or fluid flow analysis by providing rapid feedback on items being designed at the AR Station.

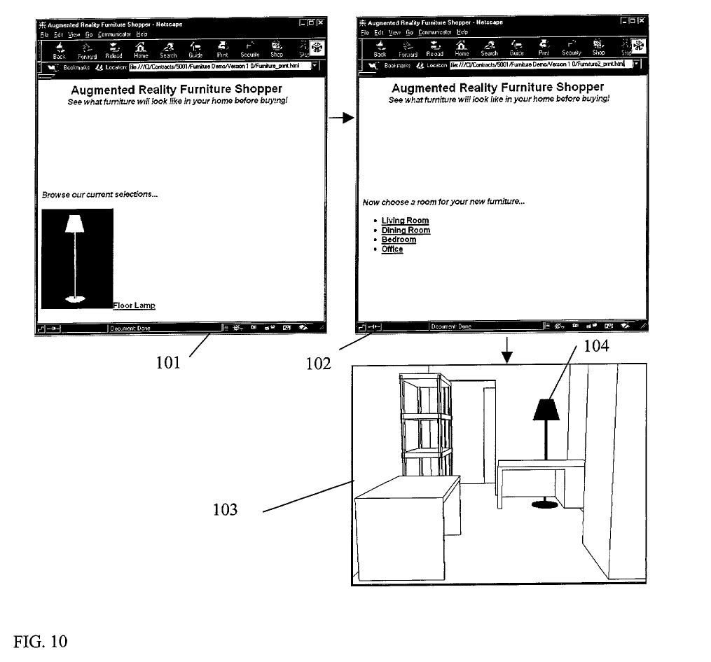

In the online shopping preferred embodiment of the invention, the Remote Non-AR Station computer 37b in FIG. 7 is a web server, and the Local AR Station computer 31b is a standard PC with a 3D accelerator card. Using an Internet-connected Local AR Station computer 31b and a web browser (for example, NETSCAPE™ NAVIGATOR™ (Netscape World Headquarters, 466 Ellis St., Mountain View, Calif. 94043-4042), a shopper may browse and preview products available on a vendor's website. FIG. 10 demonstrates how such a web page might look. The example given is for an online furniture store. Selecting a piece of furniture on a web page 101 initiates download of a 3-D model, potentially a VRML (Virtual Reality Markup Language) model, of that piece of furniture. After selecting a piece of furniture, a shopper is able to select from another web page 102 which local room in which the furniture should be placed. With a hand tracker or a tracked wand or some other means such as touchpad, keyboard, spaceball, joystick, touchscreen, and/or voice recognition technology, objects may also be placed and manipulated at the Local AR Station 3b. A wand interface, for example, may involve an AR pointer that selects objects and points to a spot in the (real) room where the user would like the (virtual) object to be placed. Another interface may involve a tracked glove that the user may employ to “grab” virtual objects and place and manipulate them in a real room.

In FIG. 10, the final stage of this embodiment is the AR viewing of the product that a user is evaluating for purchase. A user may physically walk around the real room, crouch down, etc. to evaluate the appearance of an object in his/her environment. In 103 is shown the shopper's AR view of a virtual lamp 104 as seen in a real room (the same room as in FIG. 5).

In such an online shopping embodiment, users might choose colors and textures of objects and evaluate them within an environment (the Local AR Station). For example, users may be able to alter surface textures and fabric choices for furniture and other products. A sphere map texture or SGI's CLEARCOAT™ 360 technology may be used to evaluate reflections of a real environment off a virtual object placed within that setting. This would more accurately represent a shiny product's appearance in such an environment.

AR-based lighting design is another application that can benefit from the internetworked AR invention. A lamp model (e.g., the one used in the online shopping embodiment presented above) could be given properties such that a user could turn on the lamp and see how it would affect the room's lighting conditions. Radiosity or ray tracing applied to the room can generate virtual shadows and bright spots on the existing geometry of the real room. Such lighting calculations may be done offline and displayed in real-time, or simple lighting and shadowing algorithms (e.g., OPENGL™ lighting and shadow masks) can be applied in real-time. This application could be extended for overhead lights, window placement, oil lamps, or any type of lighting users may wish to add to their homes, either indoors or outdoors. Additionally, non-light-casting objects viewed in AR can cast shadows on real-world objects using these techniques. The real-world lighting characteristics can be sampled with a camera and applied to the virtual objects to accomplish this task.

In FIG. 3, in a navigation embodiment of the invention, the Remote Non-AR Station 5 is a computer containing information relevant to navigation conditions connected via a wireless network. For a Local AR Station in a marine navigation application, frequently updated navigation information may include locations of hazards (both new and old, e.g., conditions of wrecks and debris, changing iceberg or sandbar conditions), the latest locations of other watercraft, and the updates to preferred routes for safe passage. For an AR-based aircraft navigation application, the navigation information may include locations of other aircraft or terrain, and flight paths for one's own or other aircraft in poor visibility conditions. Similarly, for AR-based land travel, the location of other vehicles, hazardous road conditions, and preferred routes may all be served by a computer over a network.

In FIG. 3, an AR-based situational awareness (SA) embodiment of the invention extends from the navigational embodiment. Information coming across a network from a number of observers can be assembled at the Local AR Station 3 to enhance a user's SA. Observers may include humans or remote sensors (e.g., radar or weather monitoring stations). The major difference between AR-based SA and AR-based navigation is that navigation is intended to guide a user along a safe or optimal path whereas SA is geared towards supplying a large amount of information to a user organized in a format that allows the user to make informed, time-critical decisions. One example of a SA application is that of AR-based air traffic control. An air traffic controller must be supplied with information available from radar and from individual airplanes. Such data could be transmitted over a network to the air traffic controller to aid him or her in making decisions about how to direct aircraft in the area.

In FIG. 3, a testing preferred embodiment would permit remote AR-based human-in-the-loop testing, where equipment testers at the Local AR Station 3 are given virtual stimuli to react to in order for the test operator to record and evaluate the response of a system. A testing embodiment of internetworked AR allows a human test controller to remotely control and record the AR test scenario from a computer that is located a distance away from the system under test.

In FIG. 3, an entertainment embodiment of internetworked AR would allow AR game players at remote sites to play against each other. In this case, both the Local AR Station 3 and the Remote Station are AR Stations 6. There may be an additional Remote Non-AR Station 5 that acts as a game server that AR station users connect to. One example of a gaming embodiment is an AR tennis game where players located on different tennis courts are able to play against each other using virtual representations of the ball and one's opponent(s) that are overlaid on real tennis courts.

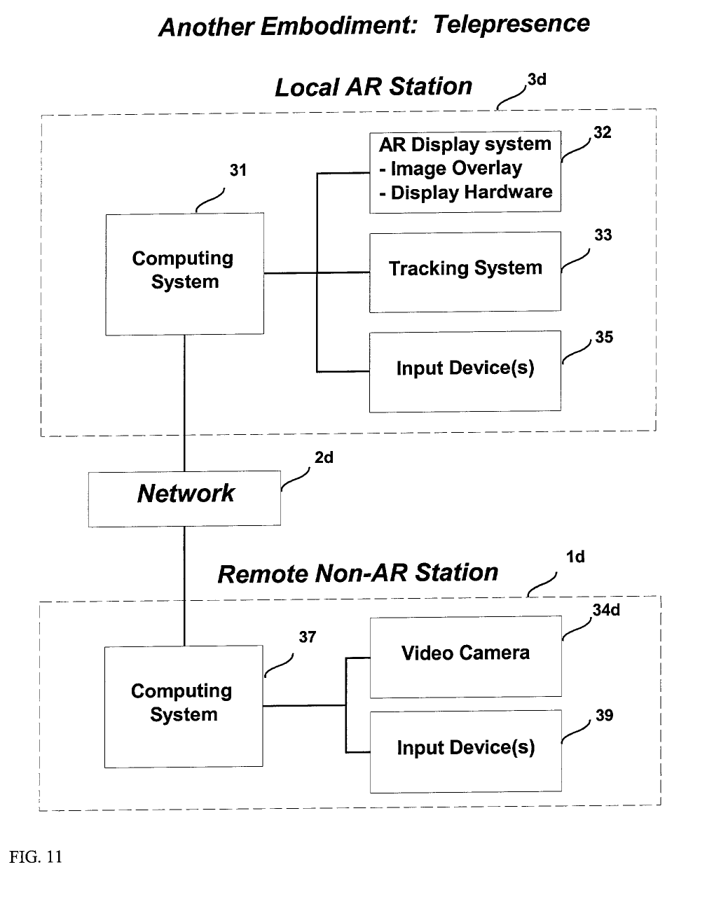

A telepresence embodiment of internetworked AR is shown in FIG. 11. This embodiment removes the camera 34 from the Local AR Station 3d and places it as 34d at Remote Non-AR Station 1d. Data from the tracking system 33 at the Local AR Station 3d can be used to control the viewing angle of the camera 34 at a Remote Non-AR Station 1d, and the camera image can be sent on the network 2d. The invention also contemplates use of two or more cameras at the Remote Non-AR Station. Augmentation of the camera image(s) can occur either at the Remote Non-AR Station 1d or at the Local AR Station 3d. In a variation of this embodiment, the camera 34d at a Remote Non-AR Station 1d can be fixed in place pointing at a reflective curved surface. The camera image transferred over the network to the Local AR Station 3d can be mapped to the inside of a virtual curved surface to remove distortion and allow the Local AR Station user to view the remote AR. Using a fixed camera allows multiple AR Station users to connect to the camera and simultaneously experience the same remote AR.

All embodiments of the invention described above can operate in a collaborative mode. The training embodiment is collaborative by nature, with the instructor (“remote collaborator” 411 in FIG. 4) and trainee (Local AR Station User 414 in FIG. 4) collaborating over the network, but the other embodiments are optionally collaborative. The invention contemplates that each of the collaborative modes of the embodiments of the invention can have the collaborators operating over an internetworked AR system according to FIG. 2. In such cases, the collaborators with the user at Local AR Station 3 can be in either AR or Non-AR Remote Stations 1 and/or Local Stations 4. For example, in FIG. 3, in the HPC embodiment, a remote collaborator at an additional Remote Non-AR Station 5 can view the HPC results on an additional remote computer 37 and comment to the Local AR Station user. The Additional Remote Station can be another AR Station or a simpler, Non-AR Remote Station. For a maintenance embodiment, the remote collaborator may be a supervisor, colleague, or an expert in the maintenance task being performed in AR in FIG. 3. For an online shopping embodiment, the remote collaborator could be a sales clerk, friend, or family member helping the Local AR Station user to choose an item to purchase. A collaborative design embodiment of the invention permits the AR-based designer to collaborate with remote colleagues over the network who can simultaneously see the same evolving design in AR, such as architectural plans, lighting designs, or landscaping overlaid onto the real world seen by the local member of the design team at the Local AR Station 3c, as in FIG. 3. In the navigation and SA embodiments, a remote person can collaborate with the person at the Local AR Station on filtering and interpreting the latest data. In the testing embodiment, the test operator can communicate with an expert tester as to the significance of test anomalies seen via the Local AR Station 3, as in FIG. 3. In FIG. 11, in the telepresence embodiment, multiple collaborators at their own AR Stations 3d, or at Remote Non-AR Stations 1d, can simultaneously view and discuss AR-enhanced images seen through the telepresence camera(s) 34d, which (as mentioned above for the telepresence embodiment) is located at the Remote Non-AR Station 1d.

One enhancement to the embodiments contemplated in this invention is the ability to send and receive voice packets over the network to allow audio communication between the remote collaborator and AR system user. Commercial software packages and APIs (application programming interfaces) exist that make such an enhancement achievable. A second system enhancement contemplated in this invention is the ability for a remote collaborator to provide visual indicators to the AR system user in the form of numerical, textual, or graphical information to aid the AR system user or to direct actions that the remote collaborator would like the AR system user to take.

The descriptions of embodiments above focus on visual augmentation, but the invention extends to augmentation of other senses as well. AR sound is a trivial addition achieved by adding headphones to the Local AR Station or by using speakers in the Local AR Station user's environment. Virtual smells can be achieved with commercial products such as those available from DIGISCENTS™ (DigiScents, Inc., http://www.digiscents.com). Force feedback and simulation of surface textures is also achievable with commercial products, such as the PHANTOM™ (SensAble Technologies, Inc., 15 Constitution Way, Woburn, Mass. 01801) or the CYBERTOUCH™ (Virtual Technologies, Inc., 2175 Park Boulevard, Palo Alto, Calif. 94306). Small, remotely controlled thermal resistors or electrical wiring can be used to control temperature or shock experiences, respectively, of the user at the Local AR Station in order to simulate heat or the touching of live electric wires. All of these augmented senses for the AR System user may be controlled and/or observed by a user at a Remote or Local Station.

### APPENDIX A

The following pages contain source code for a program developed by Creative Optics, Inc. that was used for the internetworked AR training system.

### ENABLING AN AR SYSTEM FOR INTERNETWORKED APPLICATIONS

Because the concept presented in this document has applications independent of firefighter training, the source code presented for the Local AR Station is what would be required for any AR training system to enable remote instruction over a network. The key elements are detailed below.

1. Initialize UMP

```
    if(settings.DistribMode == DISTRIBUTED)
    {
      //Initialize UMP
      cout << “Initializing UMP...” endl;
    umpInitC(NULL);
    // create sockets
    // send port is 9000
    send_socket = umpCreateSocketC(“Conference”, 9000, 0, UDP_{—}
SEND_ONLY, NO_CONVERT, QUEUED);
    if(send_socket) cout << “UMP Send Socket Created” << endl;
    // receive port is 9001
    rcv_socket = umpCreateSocketC(NULL, 0, 9001, UDP_{—}
RCV_ONLY, NO_CONVERT, QUEUED);
    if(rcv_socket) cout << “UMP Receive Socket Created” << endl;
}
```

2. Capture video

Using methods documented in the SGI Digital Media Library examples, video capture from an S-Video port can be enabled. The chosen format for this application was RGBA 640×240 video fields. This code takes a captured video buffer (unsigned char array) and reduces the data to a 160×60 pixel field for transmission in one data packet.

```
if(bufferf1)
{
    k = 0;
    for(i = 2560; i < 614400; i += 2560*4)
    {
      for(j = 0;j < 2560; j += 14)
      {
        SmallBuff[k] = bufferf1[j+i];
        j++;
        k++;
        SmallBuff[k] = bufferf1[j+1];
        j++;
        k++;
        SmallBuff[k] = bufferf1[j+i];
        k++;
      }
    }
}
```

3. Send Video

umpSendMsgC(send_socket, SmallBuff, 28800, NULL, 0, 0);

4. Receive and respond to ASCII code

```
if(umpRcvMsgC(rcv_socket, &ascii_code, 4, 100, 0) > 0)
{
    //call a function that handles keypresses
    KeyPress(ascii_code);
}
```

### ENABLING A REMOTE NON-AR STATION

The following pages contain the full source code for Remote Non-AR Station software.

/ *= = = = = = = = = = = = = = = = = = = = = = = = = = = = = = = = = = = =
=
Restrictions: The following computer code developed by Creative Optics, Inc.

is PROPRIETARY to Creative Optics, Inc.

| | |
|---|---|
| FileName: | Main. cpp |
| Purpose: | |
| Creation date: | February 7, 2000 |

Last modified in project version: 16.3

| | |
|---|---|
| Author: | Todd J. Furlong |

= = = = = = = = = = = = = = = = = = = = = = = = = = = = = = = = = = = = =*
/
#include <windows.h>
#include <math.h>
#include <stdio.h>
#include <iostream.h>
#include <UMP/ump.h>
#include <GL/gl.h>
#include <stdiostr.h>
#include “oglt.h”
void SetupConsole (void);
void reshape (void);
//UMP stuff
int rcv_socket;
int send_socket;

| | |
|---|---|
| int | winWidth, winHeight; |
| HDC | dc; |
| HGLRC | rc; |
| HWND | wnd; |

unsigned char bufferf1[160*60*3];
void Draw()
{

//recieve buffer from UMP
umpRcvMsgC(rcv_socket, bufferf1, 28800, WAIT_FOREVER, 0);
glClear (GL_COLOR_BUFFER_BIT | GL_DEPTH_BUFFER_BIT);
glMatrixMode (GL_PROJECTION);
glLoadIdentity();
glDepthMask(GL_FALSE);
glDisable (GL_BLEND);
glDisable (GL_LIGHTING);
glPixelZoom(1.0, −2.0);
glRasterPos2f(−1, 1);
glDrawPixels (160, 60, GL_RGB, GL_UNSIGNED_BYTE, bufferf1);
SwapBuffers (dc);
ValidateRect (wnd, NULL);

}
void Init(viewVolume *_vv)
{

| | |
|---|---|
| PIXELFORMATDESCRIPTOR | pfd; |
| PIXELFORMATDESCRIPTOR | tempPfd; |

| | |
|---|---|
| int | pixelFormat; |

| | |
|---|---|
| pfd.nSize = | sizeof(PIXELFORMATDESCRIPTOR); |
| pfd.nVersion = | 1; |
| pfd.dwFlags = | PFD_DRAW_TO_WINDOW \| PFD SUPPORT_OPENGL \| |

PFD_DOUBLEBUFFER;

| | |
|---|---|
| pfd.iPixelType = | PFD_TYPE_RGBA; |
| pfd.cColorBits = | 24; |
| pfd.cRedBits = | 0; |
| pfd.cRedShift = | 0; |
| pfd.cGreenBits = | 0; |
| pfd.cGreenShift = | 0; |
| pfd.cBlueBits = | 0; |
| pfd.cBlueShift = | 0; |
| pfd.cAlphaBits = | 4; |
| pfd.cAlphaShift = | 0; |
| pfd.cAccumBits = | 0; |
| pfd.cAccumRedBits = | 0; |
| pfd.cAccumGreenBits = | 0; |
| pfd.cAccumBlueBits = | 0; |
| pfd.cAccumAlphaBits = | 0; |
| pfd.cDepthBits = | 0; |
| pfd.cStencilBits = | 0; |
| pfd.cAuxBuffers = | 0; |
| pfd.iLayerType = | PFD_MAIN_PLANE; |
| pfd.bReserved = | 0; |
| pfd.dwLayerMask = | 0; |
| pfd.dwVisibleMask = | 0; |
| pfd.dwDamageMask = | 0; |

dc = GetDC(wnd);
pixelFormat = ChoosePixelFormat(dc, &pfd);
DescribePixelFormat (dc, pixelFormat, sizeof (PIXELFORMATDESCRIPTOR),
&tempPfd);
if(SetPixelFormat(dc, pixelFormat, &pfd) = = FALSE)
exit (1);
rc = wglCreateContext(dc);
wglMakeCurrent(dc, rc);
glViewport(0, 0, winWidth, winHeight);

}
void Quit ()
{

//re-enable the screen saver
SystemParametersInfo(SPI_SETSCREENSAVEACTIVE, TRUE, 0,

SPIF_SENDWININICHANGE);

wglMakeCurrent(dc, rc);
wglDeleteContext(rc);
ReleaseDC(wnd, dc);
PostQuitMessage(0);

}
void SetupConsole()
{

```
int hCrt;
FILE *hf;
static int initialized = 0;
DWORD rv;
rv = GetLastError();
if (initialized = = 1)
{
  printf(“Setup console only needs to be called once\n”);
  return;
}
AllocConsole();
// Setup stdout
hCrt = _open_osfhandle( (long)GetStdHandle(STD_OUTPUT_HANDLE), _O_TEXT );
hf = _fdopen(hCrt, “w”);
*stdout = *hf;
setvbuf(stdout, NULL, _IONBF, 0);
// Setup stderr
hCrt = _open_osfhandle( (long)GetStdHandle(STD_ERROR_HANDLE), _O_TEXT );
hf = _fdopen(hCrt, “w”);
*stderr *hf;
setvbuf(stderr, NULL, _IONBF, 0);
//Setup cout
hCrt = _open_osfhandle( (long)GetStdHandle(STD_OUTPUT_HANDLE), _O_TEXT );
hf = _fdopen(hCrt, “w”);
stdiostream ConsoleStream(hf);
ConsoleStream.sync_with_stdio();
initialized = 1;
```

}
LRESULT CALLBACK WndProc(HWND _wnd, UINT _msg, WPARAM _wParam, LPARAM
_lParam)
{

wnd = _wnd;
switch(_msg)
{

case WM_CREATE: //Do when window is created

Init (NULL);
SetTimer(wnd, 1, 1, NULL);

return 0;
case WM_SIZE: //resize window

winWidth = LOWORD(_lParam); winHeight = HIWORD(_lParam);
reshape ();

return 0;
case WM_DESTROY: //Close Window

Quit ();

return 0;
case WM_CLOSE: //Close Window

Quit ();

return 0;
case WM_KEYDOWN:

switch(_wParam)
{

case VK_ESCAPE:

Quit ();
break;

default:

return DefWindowProc (wnd, _msg, _wParam, _lParam);

}
break;

case WM_CHAR:

umpSendMsgC(send_socket, &_wParam, 4, NULL, 0, 0);
cout << “message sent” << endl;

case WM_TIMER: //equivalent of GLUT idle function

Draw ();

return 0;
break;

}
return DefWindowProc(wnd, _msg, _wParam, _lParam);

}
//Win32 main function
int APIENTRY WinMain(HINSTANCE _instance, HINSTANCE _prevInst, LPSTR
_cmdLine, int _cmdShow)
{

MSG msg ;
WNDCLASSEX wndClass;
char *className = “OpenGL”;
char *windowName = “COI Instructor Window”;
RECT rect;
//make a console window
SetupConsole ();
//Initialize UMP
cout << “Initializing UMP . . . ” << endl;
umpInitC(NULL);
// initialize UMP
rcv_socket = umpCreateSocketC(NULL, 0, 9000, UDP_RCV_ONLY, NO_CONVERT,

QUEUED);

if(rcv_socket) cout << “UMP Receive Socket Created” << endl;
send_socket = umpCreateSocketC(“Dante”, 9001, 0, UDP_SEND_ONLY,

NO_CONVERT, QUEUED);

if (send_socket) cout << “UMP Send Socket Created” << endl;
//disable the screen saver
SystemParametersInfo(SPI_SETSCREENSAVEACTIVE, FALSE, 0,

SPIF_SENDWININICHANGE);

| winWidth = 160; | |
|---|---|
| winseight = 120; | |
| wndClass.cbSize | = sizeof (WNDCLASSEX); |
| wndClass.style | = CS_HREDRAW \| CS_VREDRAW; |
| wndClass.lpfnWndProc | = WndProc; |
| wndClass.cbClsExtra | = 0 ; |
| wndClass.cbWndExtra | = 0 ; |
| wndClass.hInstance | = _instance; |
| wndClass.hCursor | = LoadCursor (NULL, IDC_ARROW) ; |
| wndClass.hbrBackground | = (HBRUSH) GetStockObject(WHITE_BRUSH); |
| wndClass.lpszMenuName | = NULL; |
| wndClass.lpszClassName | = className ; |
| wndClass.hIcon | = (HICON) LoadIcon(_instance, “logo”); |
| wndClass.hIconSm | = (HICON) LoadIcon(_instance, “logoSmall”); |

RegisterClassEx (&wndClass) ;
rect.left = 0;
rect.top = 0;
rect.right = winWidth;
rect.bottom = winHeight;
AdjustWindowRect(&rect, WS_CLIPSIBLINGS | WS_CLIPCHILDREN |

WS_OVERLAPPEDWINDOW, FALSE);

winWidth = rect.right - rect.left; // adjust width to get 640 × 480 viewing

area

winHeight = rect.bottom - rect.top; // adjust height to get 640 × 480

viewing area

wnd = CreateWindow(className, windowName,

| WS_OVERLAPPEDWINDOW \| WS_CLIPCHILDREN \| WS_CLIPSIBLINGS, | |
|---|---|
| 0, | // initial x position |
| 0, | // initial y position |

| | |
|---|---|
| winWidth, | // winWidth |
| winHeight, | // winHeight |
| NULL, | // parent window handle |
| (HMENU) NULL, | // window menu handle |
| _instance, | // program instance handle |
| NULL) ; | |

//set the current rendering context
wglMakeCurrent (dc, rc);
ShowWindow(wnd, _cmdShow);
UpdateWindow (wnd);
while (GetMessage (&msg, NULL, 0, 0))
{

TranslateMessage (&msg);
DispatchMessage (&msg);
}
return msg.wParam ;

}
void reshape (void)
{

wglMakeCurrent (dc, rc);
glMatrixMode (GL_PROJECTION);
glLoadIdentity ();
glViewport(0, 0, winWidth, winHeight);
gluPerspective(33.38789, 1.35966, .15, 80.);
glMatrixMode (GL_MODELVIEW);
Draw ();

}

Although specific features of the invention are shown in some drawings and not others, this is for convenience only, as each feature may be combined with any or all of the other features in accordance with the invention.

Other embodiments will occur to those skilled in the art are within the following claims.

What is claimed is:

1. An internetworked augmented reality (AR) system, comprising:
a. At least one Local Station, at least one of which must be a Local AR Station,
b. At least one Remote Station, and
c. A network connecting these stations.

2. The system of claim 1 wherein an AR Station is comprised of at least:
a. A computing system
b. An AR display system, and
c. A tracking system

3. The system of claim 1 wherein a Non-AR Station is comprised of at least:
a. A computing system

4. The system of claim 1 wherein the network is selected from the group of networks consisting of a local area network (LAN), a wide area network (WAN), a wireless network, and the Internet.

5. The system of claim 3 wherein a Non-AR Station computing system is selected from the group of computing systems consisting of a PC, web server, database server, and high-performance computer (HPC).

6. The system of claim 3 wherein there is equipment allowing a human to use at least one Station in addition to the required Local AR Station.

7. The system of claim 5 wherein an AR Station user can remotely interact with a HPC that performs computationally intensive calculations.

8. The system of claim 5 wherein an AR Station user can perform shopping online by downloading items from a web server for placement, evaluation, and interaction in the user's own environment.

9. The system of claim 5 wherein an AR Station user is aided in maintenance tasks by accessing information from a remote database server.

10. The system of claim 5 wherein an AR Station user is aided in design tasks by accessing information from a remote database computer.

11. The system of claim 1 further including means to capture video from an AR Station and transmit it over a network to another Station.

12. The system of claim 6 wherein an AR Station user is a trainee/student and another Station user is an instructor/teacher.

13. The system of claim 6 wherein an AR Station user can collaborate with another user.

14. The system of claim 6 wherein a user at another Station can control the experience at an AR Station via an input device.

15. The system of claim 6 wherein a user at another Station can observe the experience at an AR Station via a live video feed.

16. The system of claim 6 wherein a user at another Station can communicate with a person at an AR Station by voice via audio feed(s).

17. The system of claim 6 wherein a user at another Station can visually communicate with an AR Station user via graphical overlays in the field of view of the AR Station user.

18. The system of claim 5 wherein an AR Station user is aided in navigation by accessing frequently updated information over a network.

19. The system of claim 6 wherein a user at another Station controls a testing program at an AR Station.

20. The system of claim 5 wherein an AR Station user is aided in situational awareness (SA) by accessing frequently updated information over a network.

21. The system of claim 6 wherein an AR Station user can play a game with at least one other user at another Station.

22. The system of claim 15 wherein at least one live video feed is from the first person perspective as seen by an AR Station user.

23. The system of claim 15 wherein at least one live video feed is from a non-first-person perspective camera.

24. The system of claim 23 wherein a live video feed is from at least one movable camera controllable remotely from a Station user.

25. The system of claim 6 wherein a user at a Station can view from any viewpoint a virtual representation of an AR scenario, which includes virtual representations of an AR Station user or users.

26. The system of claim 25 wherein a user at a Station can select a virtual representation of an AR Station user to read information about that particular user.

27. The system of claim 6 wherein a user at a Station can observe the effects of a stimulus which results in an AR Station user perceiving sounds from objects in AR.

28. The system of claim 6 wherein a user at a Station can observe the effects of a stimulus which results in an AR Station user perceiving forces or surface textures (haptic feedback) from objects in AR.

29. The system of claim 6 wherein a user at a Station can observe the effects of a stimulus which results in an AR Station user perceiving smell from objects in AR.

30. The system of claim 6 wherein a user at a Station can observe the effects of a stimulus which results in an AR Station user perceiving heat and cold from objects in AR.

31. The system of claim 6 wherein a user at a Station can observe the effects of a stimulus which results in an AR Station user perceiving electrical shock from objects in AR.

32. The system of claim 2 wherein the effects onto and from real objects of reflections, shadows, and light emissions from virtual objects downloaded from a web server are seen by an AR Station user.

33. The system of claim 3 wherein an AR Station user can augment telepresence imagery with virtual imagery by adding a video camera and image capture capability to a Non-AR Station to capture and send video back to an AR Station for viewing by the user.

34. The system of claim 33 wherein a motion tracking system at an AR station controls a mechanized camera mount at a Non-AR Station.

35. The system of claim 33 wherein a video camera is stationary and aimed at a reflective curved surface, and the video image received at the AR Station is mapped to the inside of a virtual curved surface for undistorted viewing of the camera scene.

36. The system of claim 2 further including at least one video camera.

37. The system of claim 2 further including at least one input device.

38. The system of claim 3 further including at least one input device.

39. The system of claim 5 wherein an AR Station user is aided in design tasks by accessing information from a remote HPC (high performance computer).

40. The system of claim 6 wherein a user at a Station can visually communicate with an AR Station user via text overlays in the field of view of the AR Station user.

41. The system of claim 25 wherein a user at a Station can select a virtual representation of an AR Station user to send information to that particular user.

42. The system of claim 6 wherein a user at a Station can control a stimulus which results in an AR Station user perceiving sounds from objects in AR.

43. The system of claim 6 wherein a user at a Station can control a stimulus which results in an AR Station user perceiving forces or surface textures (haptic feedback) from objects in AR.

44. The system of claim 6 wherein a user at a Station can control a stimulus which results in an AR Station user perceiving smell from objects in AR.

45. The system of claim 6 wherein a user at a Station can control a stimulus which results in an AR Station user perceiving heat and cold from objects in AR.

46. The system of claim 6 wherein a user at a Station can control a stimulus which results in an AR Station user perceiving electrical shock from objects in AR.
